(19) United States
(12) Patent Application Publication
(10) Pub. No.: US 2007/0290791 A1
(43) Pub. Date: Dec. 20, 2007

(54) RFID-BASED SECURITY SYSTEMS AND METHODS

(75) Inventor: Naresh Batra, Saratoga, CA (US)

Correspondence Address: Zilka-Kotab, PC, P.O. BOX 721120, SAN JOSE, CA, 95172-1120, US

(73) Assignee: INTELLEFLEX CORPORATION

(21) Appl. No.: 11/423,407

(22) Filed: Jun. 9, 2006

(51) Int. Cl. G08B 13/00

(52) U.S. Cl. 340/5.31; 340/5.8; 726/20; 340/10.5; 726/9

(57) ABSTRACT

RFID-based systems and methods are presented. A portable electronic device according to one embodiment of the present invention includes an electrical system, a controller coupled to the electrical system, a display screen coupled to the electrical system, input devices coupled to the electrical system, and an RFID tag coupled to the electrical system such that removal or disablement of the tag causes disablement of at least some functionality of the device. A Radio Frequency Identification (RFID) system according to an embodimient of the present invention includes an RFID device tag coupled to a device and an RFID user tag associated with a user. The device tag is associated with the user tag. At least some functionality of the device is disabled based on whether or not a presence of the user tag is detected within a vicinity of the device tag.

### FIELD OF THE INVENTION

The present invention relates to Radio Frequency Identification (RFID) systems and methods, and more particulary, this invention relates to RFID-based security schemes.

### BACKGROUND OF THE INVENTION

Automatic identifcation (“Auto-ID”) technology is used to help machines identify objects and capture data automatically. One of the earliest Auto-ID technologies was the bar code, which uses an alternating series of thin and wide bands that can be digitally interpreted by an optical scanner. This technology gained widespread adoption and near-universal acceptance with the designation of the Universal Product Code (“UPC”)—a standard governed by an industry—wide consortium called the Uniform Code Council. Formally adopted in 1973, the UPC is one of the most obiquitous symbols present on virtually all manufactured goods taday and has allows for enormous efficiency in the tracking of goods through the manufacturing, supply, and distribution of various goods.

However, the bar code still requires manual interrogation by a human operator to scan each tagged object individually with a scanner. This is a line-of-sight process that has inherent limitaions in speed an dreliarbility. In addition, the UPC bar codes only allow for manufacturer and product type information to be encoded into the barcode, not the unique item's serial number. The bar code on one milk carton is the same as every other, making it impossible to count objects or individually check expiration dates, much less find one particular carton of many.

Currently, retail items are marked with barcode labels. These printed labels have over 40 “standard ” layouts, can be mis-printed, smeared, mis-positioned and mis-labeled. In transit, these outer labels are often damaged or lost. Upon receipt, the pallets typically have to be broken-down and each case scanned into an enterprise system. Error rates at each point in the supply chain have been 4-18% thus creating a billion dollor inventory visibility problem. However, Radio Frequency Identification (RFID) allows the physical layer of actual goods to automatically be tied into software applications, to provide accurate tracking.

The emerging RFID technology employs a Radio Frequency (RF) wireless link and ultra-small embedded computer chips, to overcome these barcode limitations. RFID technology allows physical objects to be identified and tracked via these wireless “tags”. It functions like a bar code that communicates to the reader automatically without needing manual line-of-sight scanning or singulation of the objects.

Addition of battery power to RFID tags has greatly increased the range in which reliable communication with the tag is possible. This has in turn made new applications possible.

### SUMMARY OF THE INVENTION

RFID-based systems and methods are presented. A portable electronic device according to one embodiment of the present invention includes an electrical system, a controller coupled to the electrical system, a display screen coupled to the electrical system, input devices coupled to the electrical system, and an RFID tag coupled to the electrical system such that removel or disablement of the tag causes disablement of at least some functionality of the device.

The tag may be integrated into the electrical system of the device. For example, removal of the tag may physically sever a power supply to at least a portion of the electrical system. Removal of the tag may physically sever a communication line to the display screen and/or a communication line of at least one of the input devices. Preferably, removal of the tag permanently disables all functionality of the device.

Illustrative portable electronic devices include laptop personal computers (PCs), handheld computing devices such as PDAs, mobile telephones and other devices with a telephone function, etc. In the laptop PC case, the tag may be physically positioned behind an emblem on a housing of the laptop personal computer.

In some embodiments of the present invention, the tag gathers biometric data. The tag may selectively enable functionality of the device based on the biometric data. For example, reference biometric data is programmed into the tag, the reference biometric data being compared with the gathered biometric data for determining whether to selectively enable functionality of the device.

A Radio Frequency Identification (RFID) system according to an embodiment of the present invention includes an RFID device tag coupled to a device and an RFID user tag associated with a user. The device tag is associated with the user tag. At least some functionality of the device is disabled based on whether or not a presence of the user tag is detected within a vicinity of the device tag.

Removal of the device from a vicinity of the user tag may be one event that causes disablement of at least some functionality of the device. In one such embodiment, an RFID interrogator is in communication with the device tag and user tag, where the removal of the device from the vicinity of the user tag is detected by the RFID interrogator. In another such embodiment, the removal of the device from the vicinity of the user tag is detected by an RFID interrogator operating in a passive mode. Yet another embodiment includes a first RFID interrogator in communication with the device tag and user tag in an active mode, and a second RFID interrogator operating in a passive mode. The device tag and the user are at least periodically monitored by the first RFID interrogator, where the removal of the device from the vicinity of the user tag os detected by analyzing presence or lack of communication between the tags and the first and second RFID interrogators. Additionally, at least some functionality of the device may be disabled if the device tag is detected by the second RFID interrogator and the user tag is not also detected by the second RFID interrogator.

As mentioned above, detaching the device tag from the device may cause disablement of at least some functionality of the device. Similarly, biometric data may be gathered to enable/disable functionality.

A method for selectively enabling and disabling a device includes receiving an authorization code from an interrogator, the authorization code indicating that a valid user tag has been detected. Functionality of the device is enabled upon receiving the authorization code. Functionality of the device is disabled upon receiving a transmission from an interrogator indicating that a valid user tag is not detected.

A method for selectively enabling or disabling a device includes detecting a device tag coupled to a device, searching for a valid tag, and performing at least one of the following operations: instructing the device tag to disable the device if a valid user tag is not detected and/or instructing the device tag to enable the device if a valid user tag is detected. As mentioned above, detecting the device tag and searching for the valid user tag may be performed in a passive mode. Also, the device may become disabled if the device tag is removed.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the prefered mode of use, reference should be made to the following detailed description read in conjunction with the accompanying drawings.

FIG. 1 is a system diagram of an RFID system according to one embodiment of the present invention.

FIG. 2 is a system diagram for an integrated circuit (IC) chip for implementaion in an RFID tag according to one embodiment of the present invention.

FIG. 3 is a system diagram of an electronic device having a device tag coupled thereto according to one embodiment of the present invenion.

FIG. 4 is a system diagram of an electronic device having a device tag coupled thereto according to one embodiment of the present invention.

FIG. 5 is a system diagram of an electronic device having a device tag coupled thereto according to one embodiment of the present invention.

FIG. 6 is a system of an RFID system according to one embodiment of the present invention.

FIG. 7 is a perspective view of a laptop PC according to one embodiment of the present invention.

FIG. 8 is a perspective view of a vehicle according to one embodiment of the present invention.

FIG. 9 is a process diagram of a method for selectively enabling and disabling a device to an embodiment of the present invention.

FIG. 10 is a process diagram of a method for selectively enabling or disabling a device according to an embodiment of the present invention.

FIG. 11 is a process diagram of a method for selectively enabling or disabling a device according to an embodiment of the present invention.

FIG. 12 is a process diagram of a method for selectively preventing disablement of a device having a device tag coupled thereto according to one embodiment of the present invention.

### BEST MODE FOR CARRYING OUT THE INVENTION

The follweing description is the best mode presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

Unless otherwise specifically definded herein, all terms are to be given their broadest possible inerpretation including meanings implified from the specification as well as meanings understood by those skilled in the art and as defined in dictionaries, treatises, etc.

The use of RFID tags are quickly gaining popularity for use in the monitoring and tracking of an item. RFID technology allows a user to remotely store and retrieve data in connection with an item utilizing a small, unobtrusive tag. As an RFID tag operates in the radio frequency (RF) portion of the electromagnetic spectrum, an electromagnetic or electrostatic coupling can occur between an RFID tag affixed to an item and an RFID tag reader. This coupling is advantageous, as it precludes the need for a direct contact or line of sight connection between the tag and the reader.

Utilizing an RFID tag, an item may be tagged at a period when the initial properties of the item are known. For example, this first tagging of the item may correspond with the beggining of the manufacturing process, or may occur as an item is first packaged for delivery. Electronically tagging the item allows for subsequent electronic exchanges of information between the tagged item and a user, wherein a user may read information stored within the tag and may additionally write information to the tag.

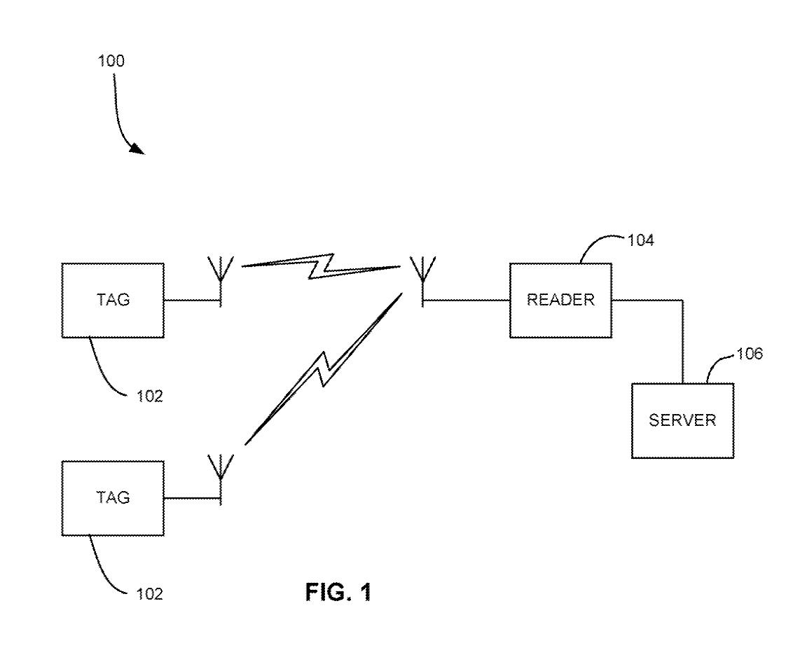

As shown in FIG. 1, an RFID system 100 typically includes RFID tags 102, an interrogator or “reader” 104, and an optical server 106 or other backend system which may include databases containing information relating to RFID tags and/or tagged items. Each tag 102 may be coupled to an object. Each tag 102 includes a chip and an antenna. The chip includes a digital decoder needed to execute the computer commands that the tag 102 receives from the interrogator 104. The chip may also include a power supply circuit to extract and regulate power from RF interrogator; a detector to decode signals from the interrogator; a backscatter modulator, a transmitter to send data back to the interrogator; anti-collision protocol circuits; and at least enough memory to store its unique identification code, e.g., Electronic Product Code (EPC).

The EPC is a simple, compact identifier that uniquely identifies objects (items, cases, pallets, location, etc.) in the supply chain. The EPC is built around a basic hierarchical idea that can be used to express a wide variety of different, existing numbering systems, like the EAN.UCC System Keys, UID, VIN, and other numbering systems. Like many current numbering schemes used in commerce, the EPC is divided into numbers that identify the manufacturer and product type. In addition, the EPC uses an extra set of digits, a serial number, to identify unique items. A typical EPC number contains:
1. Header, which identifies the length, type, structure, version and generation of EPC;
2. Manager Number, which identifies the company or company entity;
3. Object Class, similar to a stock keeping unit or SKU; and
4. Serial Number, which is the specific instance of the Object Class being tagged.

### Additional fields may also be used as part of the ECP in order to properly encode and decode information from different numbering systems into their native (human-readable) forms.

Each tag 102 may also store information about the item to which coupled, included but not limited to a name or type of item, serial number of the item, date of manufacture, place of manufacture, owner identification, origin and/or destination information, expiration date, composition, information relating to or assigned by governmental agencies and regulations, etc. Furthermore, data relating to an item can be stored in one or more databases linked to the RFID tag. These databases do not reside on the tag, but rather are linked to the tag through a unique identifier (s) or referenc key (s).

Communication begins with an interrogator 104 sending out signals via radio wave to find a tag 102. When the radio wave hits the tag 102 and the tag 102 recognizes and responds to the interrogator's signal, the interrogator 104 decodes the data programmed into the tag 102. The information is then passed to a server 106 for processing, storage, and/or propagation to another computing device. By tagging a variety of items, information about the nature and locationof goods can be known instantly and automatically.

Many RFID systems use reflected or “backscattered” radio frequency (RF) waves to transmit information from the tag 102 to the interrogator 104. Since passive (Class-1 and Class-2) tags get all of their power from the interrogator signal, the tags are only powered when in the beam of the interrogator 104.

The Auto ID Center EPC-Compliant tag classes are set forth below:

Class-1
Identity tags (RF user programmable, range ˜3 m)
Lowest cost

Class-2
Memory tags (20 bit address space programmable at ˜3 m)
Security & privacy protection
Low cost

Class-3
Semi-passive tags (also called semi-active tags)
Battery tags (256 bits to 2M words)
Self-Powered Backscatter (internal clock, sensor interface support)
˜100 meter range
Moderate cost

Class-4
Active tags
Active transmission (permits tag-speaks-operating modes)
˜30,000 meter range
Higher cost

In RFID systems where passive receivers (i.e., Class-1 and Class-2 tags) are able to capture enough energy from the transmitted RF to power the device, no batteries are necassary. In systems where distance prevents powering a device in this manner, an alternantive power source must be used. For these “alternate” systems (also known as semi-active or semi-passive), batteries are the most common form of power. This greatly increases read range, and the reliability of tag reads, because the tag does not need power from the interrogator to respond. Class-3 tags only need a 5 mV signal from the interrogator in comparison to the 500 mV that Class-1 and Class-2 tags typically need to operate. This 100:1 reduction in power requirement along with the reader's ability to sense a very small backscattered signal enables the tag permits Class-3 tags to operate out to a free space distance of 100 meters or more compared with a Class-1 range of only about 3 meters. Note that semi-passive and active tags may also operate in passive mode, using only energy captured from an incoming RF signal to operate and respond.

Active, semi-passive and passive RFID tags may operate within various regions of the radio frequency spectrum. Low-frequency (30 KHz to 500 KHz) tags have low system costs and are limited to short reading ranges. Low frequency tags may be used in security access and animal identification applications for example. High-frequency (860 MHz to 960 MHz and 2.4 GHz to 2.5 GHz) tags offer increased read rangesand high reading speeds. One illustrative application of high frequency tags is automated toll collection on highways and interstates.

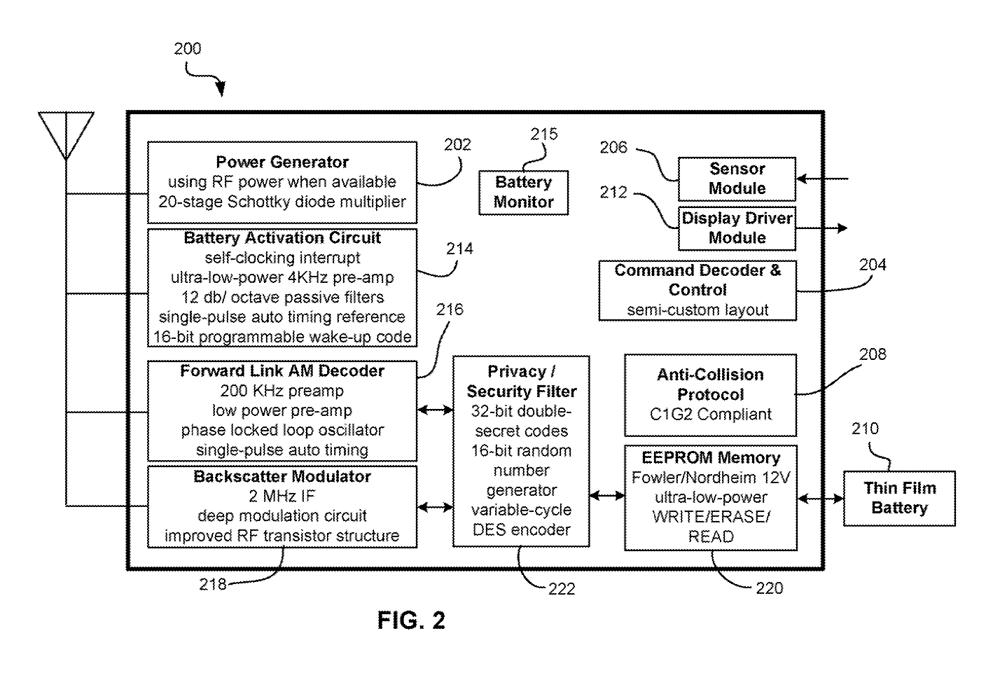

Embodiments of the present invention are preferably implemented in a Class-3 or higher Class chip (processor). FIG. 2 depicts a circuit layout of a Class-3 chip 200 according to an illustrative embodiment for implementation in an RFID tag. This Class-3 chip can form the core of RFID chips appropriate for many applications such as identification of pallets, cartons, containers, vehicles, or anything where a range of more than 2-3 meters is desired. As shown, the chip 200 includes several industry-standard circuits including power generation and regulation circuit 202, a digital command decoder and control circuit 204, a sensor interface module 206, a C1G12 interface protocol circuit 208, and a power source (battery) 210. A display driver module 212 can be added to drive a display.

A battery activation circuit 214 is also present to act as a wake-up trigger. In brief, many portions of the chip 200 remain in hibernate state during periods of inactivity. A hibernate state may mean a low power state, or a no power state. The battery activation circuit 214 remains active and processes incoming signals to determine whether any of the signals contain an activate command. If one signal does contain a valid activate command, additional portions of the chip 200 are wakened from the hibernate state, and communication with the interrogator can commence. In one embodiment, the battery activation circuit 214 includes an ultra-low-power, narrow-bandwidth preamplifier with an ultra low power static current drain. The battery activation circuit 214 also includes a self-clocking interrupt circuit and uses an innovative user-programmable digital wake-up code. The battery activation circuit 214 draws less power during its sleeping state and is much better protected against both accidental and malicious false wake-up trigger events that otherwise would lead to pre-mature exhaustion of the Class-3 tag battery 210. While any type of battery activation circuit known in the art can be potentially integrated into the system, an illustrative battery activation circuit 214 is described in copending U.S. patent application Ser. No. 11/007,973 filed Dec. 8, 2004 with title “BATTERY ACTIVATION CIRCUIT”, which is herein incorporated by reference.

A battery monitor 215 can be provided to monitor power usage in the device. The information collected can then be used to estimate a useful remaining life of the battery.

A forward link AM decoder 216 uses a simplified phase-lock-loop oscillator that requires an absolute minimum amount of chip area. Preferably, the circuit 216 requires only a minimum string of reference pulses.

A backscatter modulator block 218 preferably increases the backscatter modulation depth to more than 50%.

A memory cell, e.g., EEPROM, is also present. In one embodiment, a pure, Fowler-Nordheim direct-tunneling-through-oxide mechanism 220 is present to reduce both the WRITE and ERASE currents to about 2 μA/cell in the EEPROM memory array. Unlike any RFID tags built to date, this will permit designing of tags to operate at maximum range even when WRITE and ERASE operations are being performed. In other embodiments, the WRITE and ERASE currents may be higher or lower, depending on the type of memeory used and its requirements.

The module 200 may also incorporate a highly-simplified, yet very effective, security encryption circuit 222. Other security schemes, secret handshakes with interrogators, etc. can be used.

Only four connection pads (not shown) are required for the chip 200 to function: Vdd to the battery, ground, plus two antenna leads to support multi-element omni-directional and isotropic antennas. Sensors to monitor temperature, shock, tampering, etc. can be added by appending an industry-standard I²C or SPI interface to the core chip.

It should be kept in mind that the present invention can be implemented using any type of tag, and the circuit 200 described above is presented as only one possible implementation.

Many types of devices can take advantage of the embodiments disclosed herein, including but not limited to RFID systems and other wireless devices/systems. To provide a context, and to aid in understanding the embodiments of the invention, much of the present description shall be presented in terms of an RFID system such as that shown in FIG. 1. It should be kept in mind that this done by way of example only, and the invention is not to be limited to RFID systems, as one skilled in the art will appreciate how to implement the teachings herein into electronics devices in hardware and/or software, or combination of the two. Examples of hardware include Application Specfic Integrated Circuits (ASICs), printed circuits, monolithic circuits, reconfigurable hardware such as Field Programmable Gate Array (FPGAs), etc. The invention can also be provided in the form of a computer program product comprising a computer readable medium having computer code thereon. A computer raedable medium can be included any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

A computer for storing and/or executing the code and/or performing the processes described herein can be any type of computing device, including a personal computer (PC), laptop PC, handheld device (e.g., personal digital assistant (PDA)), portable telephone, etc.

As mentioned above, RFID tags may be coupled to objects, each tag being associated with and optionally storing information about the object to which coupled. A tagged object can be identified and located by identifying and locating the tag coupled to it.

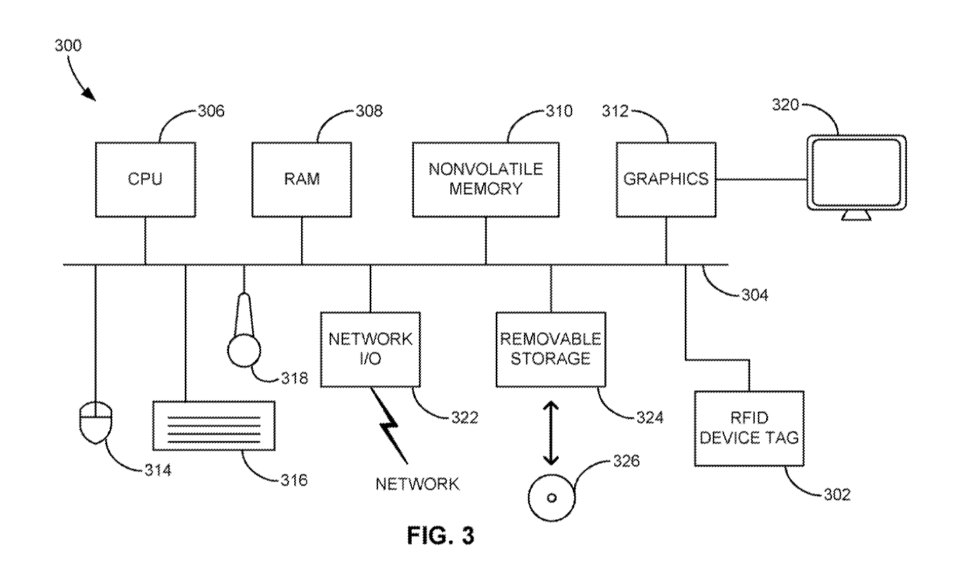

FIG. 3 illustrates an electronic device 300 with RFID device tag 302 coupled thereto according to one embodiment of the present invention. As alluded above, such an electronic device may be any type of computing device, including a PC, as well as portable electronic devices such as a laptop PC, handheld device (e.g., personal digital assistant (PDA)), portable telephone, etc. The electronic device may also be a consumer good such as an electric hand tool, a kitchen device, home electronics, etc. The electronic device may also be a vehicle such as an automobile, airplane, tractor, etc.

As shown, the divice 300 includes an electrical system 304. The elctrical system 304 may include wiring for connecting the various components of the device 300, a power supply, various control circuitry, a system bus, etc. A controller 306 is coupled to the electrical system 304, and controls several of the other components of the device 300. The controller 306 can be microprocessor (as shown) that executes instructions in a computer code, or any type of control logic. Memory including Random Access Memoery (RAM) 308 and nonvolatile memory 310 (e.g., hard disk drive) store the code or portions thereof, as well as data, during performance of the processes set forth herein. A graphics rendering subsystem 312 may also be present, and can include a separate graphics processeor and additional memory.

Various In/Out (I/O) devices are also present suah as a keyboard 314, mouse 316, microphone 318, etc. allow a user to provide user intsructions to the device 300. A display device 320 such as a monitor or screen outputs graphical information to the user. If a graphics subsystem 312 is present (as shown), the display device 320 can be coupled to the graphics subsystem 312 instead of directly to the system bus. A network interface 322 may also be providede to allow the device 300 to connect tp remote computing devices for a variety of purposes including data upload, data download, etc. A media port 324 such as a DVD reader/writer of FLASH memoery port may be present for eading code from a computer readable medium 326.

The device tag 302 allows an interrogator to detect the presennce of the device 300 and identify th device 300. The device tag 302 may thus be used as part of a security system that detects attempts to remove the device 300 from an area and engages an alarm. The device tag 302 also allows tracking of ownership, e.g., storing identifiers of previous owners or custodians of the tagged device 300. The device tag 302 further allows tracking of the device 300, e.g., to determine its presence and/or location. The device tag 302 also enables other functionality, as will soon become apparent.

Because the device 300 may be tracked as long as device tag 302 is coupled thereto, a thief may attempt to remove the device tag 302 in order to thwart the security system. To prevent this, removal or disablement of the device tag 300 preferably causes disablement of at least some functionality of the device 300, and prefeably all functionality od the device 300. The phase “cause disablement” is meant to include, in addition to its plain English meanings, e.g., causing otherwise normally or initially operating functionality to be disabled, but also not allowing normally or initially noneneabled functionality to become enabled or avialeble. Examples of functionality that can be disabled includes, but is not limited to, graphical output on the display device 320, ability to inout commands via the input devices 314-318, access to the RAM 308 or nonvolatile memory 310, ability to connect to the network, ability to transfer data via the network or to removable media 326 from the media port 324, etc.

Whether removal of the device tag 302 causes disablement of some or all of the device functionality will depend on how the device 300 is programmed to operate upon removal of the device tag 302 and/or how the device tag 302 is coupled to the device 300. In the former case, the device 300 may be programmed to verify that the device tag 302 is coupled to the device 300 prior to allowinng the deice 300 to perform certain functions such as start up. In one example, the device 300 checks for presence of the device tag 302 during a startup sequence. If the tag is not found, the device 300 turns off. Accordingly, the device 300 would not start.

The device tag 302 may be an add-on feature that is coupled to the device 300 after manufacture. The device tag 302 can be coupled externally to the device 300, for example, via a Universal Serial Bus (USB) port of the device 300, PCMCIA slot, etc. The device tag 302 may thus function like an access key such that a user merely need detach the device tag 302 from the device 300 to lock the device 300.

The device tag 302 can also be coupled and/or positioned internally to the device housing.

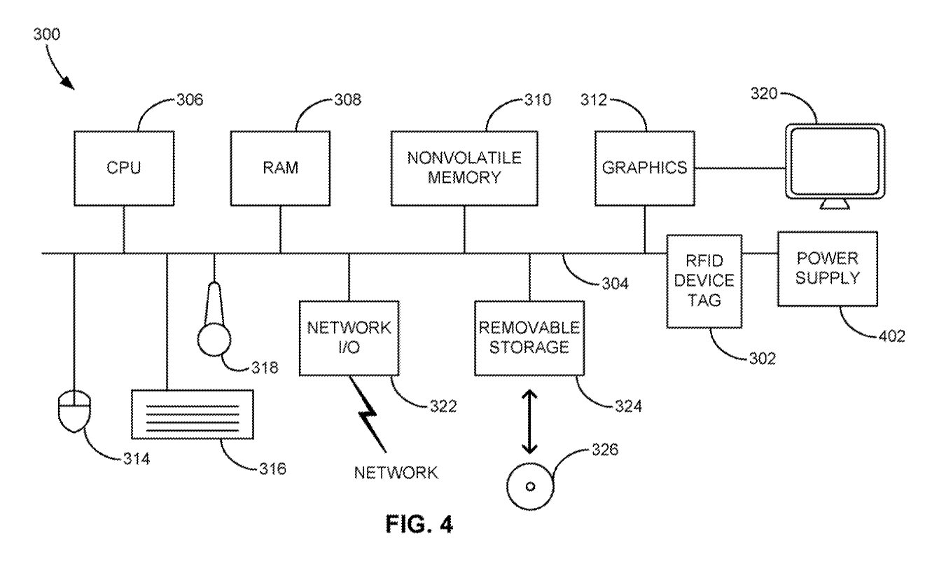

in preferred embodiments, the tag is intergrated into the elctrical system of the device. FIG. 4 illustrates an embodiment where the power supply 402 to one or more of the device components passes through the device tag 302 such that removal of the device tag 302 physically severs a power supply to at least a portion of the elctrical system 304. The device tag 302 may include a pass-through electrical junction with plugs that cooperate with sockets of the electrical system. Preferably, the power supply line passes through the device tag housing so that forcible removal of the device tag 302 breaks the power supply line. To enable this, the power supply line may be molded into or soldered to the tag housing or circuitry.

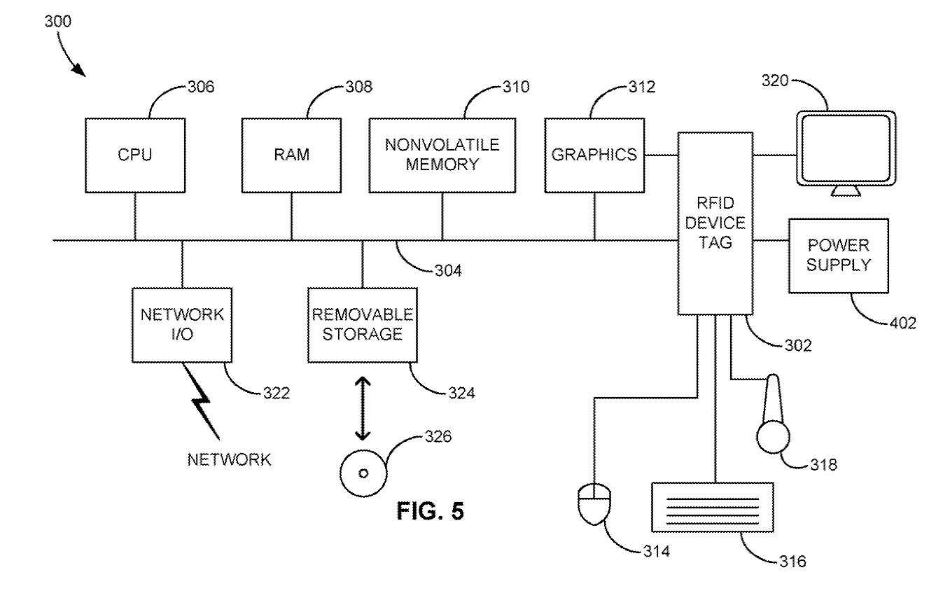

FIG. 5 illustrates an embodiment where removal of the device tag 302 physically severs a communication line to the display device 320 and/or a communication line of the least one of the input devices 314-318.

In some embodiments of the present invention, the device tag gathers biometric data. The biometric sensor may be positioned on the device tag itself, on the device and in communication with the device tag, or be carried by a handheld remote transmitter, for example. The biometric sensor may be a fingerprint sensor, a voice pattern sensor, a facial pattern sensor, a skin pattern sensor, a venous pattern senssor, a hand sensor, a retinal scanner, etc. for example. The tag may selectively enable functionality of the device based on the biometric data. For instance, refernec biometric data is programmed into the tag, the referce biometric data being compared with the gathere biometric data for determining whether to slectively enable functionality of the device. The reference biometric data may be entered by the user at the time of purchase, after purchase, by download from a stored file, etc. The reference data may be gathered by performing a scan of the particular aspect of the user. For example, reference fingerprint scan data may be derived from the first fingerprint scan of the owner. Thereafter, the biometric sensor scans the fingerprint of the user and compoares it to the stored reference fingerprint data.

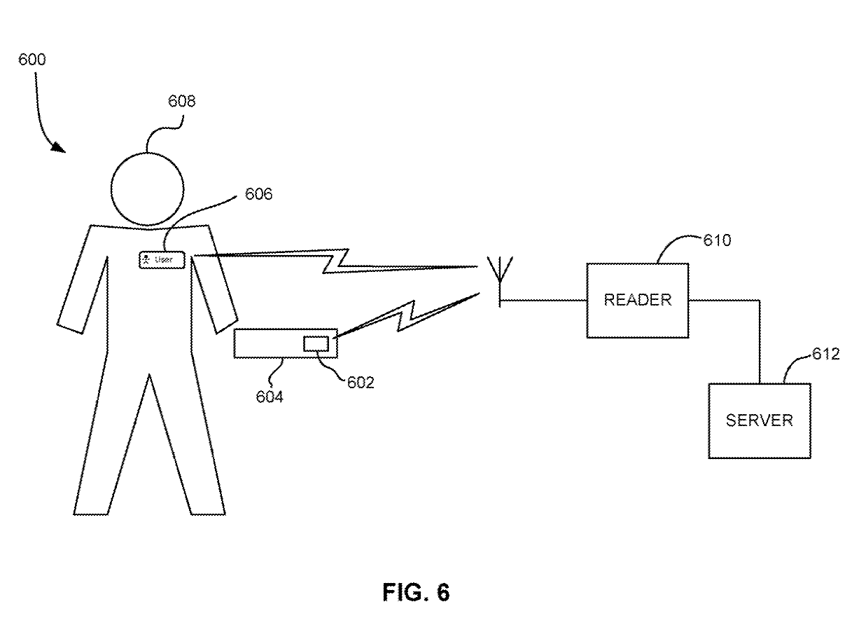

In a further embodiment, behavior of the tag coupled to the device is in some way dependent upon the presence of a “user tag” associated with a user. FIG. 6 illustrates an RFID system 600 according to an embodiment of the present invention. As shown, the system 600 includes an RFID device tag 602 coupled to a device 604. The system 600 also includes an RFID user tag 606 associated with a user 608. The device tag 602 is associated with the user tag 606 in a database, which may be resident on the interrogator 610, or stored in a backend system 612. At least some functionality of the device 604 is disabled based on whether or not a presence of the user tag 606 is detected within a vicinity of the device tag 602.

The user tag 606 can be part of a security badge, pass key, etc. that is specifically associated with a user 608 or particular class of authorized users. The device tag 602 does not allow the device 604 to operate unless the user tag 606 is in proximity to the device 604, and the user tag 606 matches a list of authorized IDs. The device tag 602 may also limit the functionality of the device 604 or its features based on the status of the user 608 associated with the user tag 606. In this way, unauthorized users can be prevented from using, say, someone else's computer terminal, or may be allowed to use it but only for limited things such as surfing the company intranet.

Removal of the device 604 from a vicinity of the user tag 606 may be another event that causes disablement of at least some functionality of the device 604. In one such embodiment, an RFID interroggator is in communication with the device tag 602 and user tag 606, where the removal of the device 604 from the vicinity of the user tag 606 is detected by the RFID interrogator. In another such embodiment, the removal of the device 604 from the vicinity of the user tag 606 oids detected by an RFID interrogator operating in a passive mode. Yet another embodiment includes a first RFID interrogator in communication with the device tag 602 and user tag 606 in an active mode (for active or semi-passive communications), and a second RFID interrogator operating in a passive mode. The device tag 602 and the user tag 606 are at least periodically monitored by the first RFID interrogator, where the removal of the device 604 form the vicinity of the user tag 606 is detected by analyzing presence or lack of communication between the tags and the first and second RFID interrogators. Additionally, at least some functionality of the device 604 may be disabled of the device tag 602 is detected by the second RFID interrogator and the user tag 606 is not also detected by the second RFID interrogator.

The device tag 602 may be in operative communication with the user tag 606 via direct communication between the tags. The device tag 602 may be in operative communication with the user tag 606 via communication moderated by an interrogator. For example, the tags may communicate with each other through the interrogator. Or, the tags may not communicate with eahc other directly at all; rather interrogator communicates with each tag individually.

In a variation on the previous examples, if the tagged device is moved from one area to another by a user not having a user tag indicating that the user is authorized to move the device, the device tag my disable the device to which coupled. In one example of use, assume the owner of the laptop PC takes the laptop PC to and from work, passing by a door-mounted interrogator each time he passes through the door. The interrogator queries the user tag (ID badge) and the device tag on the laptop PC, verifies that the device tag is associated with the user tag, and if so, may log the activity. The readrer may or may not provide any instructions to the laptop tag; either way indicating that the laptop PC will continue to operate normally. If the user tag is not associated with the device tag, the interrogator instructs the device tag to disable the device. Alternatively, the device tag may be programmed to default to disabling the device when passing within range of a reader or predefined sugnal unless instructed not to disable the device. The reader would then provide instructions indicating the user tag is associated with a user authorized to transport the laptop. In either scenario, if an unauthorized user were to carry the laptop out of the building, tha tag would disable the laptop PC.

To prevent the system from erroneously allowing transportation of the tagged device, the door-mounted readers in the previous example may have a a limited range so that they do not pick up the owner's user tag from, say, the break room, while a theif carries the device out the back door. A limited range may be created by operating the door-mounted readers in a passive mode. To prevent an unauthorized person from simply passing the laptop through a window, the device tag may periodically or continuously receive a signal from a long range interrogator. As soon as the device tag no longer receives the signal, it disables the laptop PC, unless the device tag has received an override code from the passive door-mounted readers. The system knows to send the override code to the device tag, since it has been monitoring the device tag's presence in the building via the long range interrogator.

In an alternate embodiment of the present invention, the interrogator analyzes the relative strengths of the signals from the user tag and device tag to estimate the distance differential therebetween. This in turn enables determination of whether or not the tags are in close proximity to each other. If the strengths of the tag signals vary by more than a predetermined amount, the device tag may disable the device.

An alarm can be placed at the door, which emits an audible and/or visual alarm if the object is taken through the door by one without an authorized user tag.

An administrator or other authorized user can perform a manual override if necessary, e.g., to let a technician take the laptop PC to a shop for repair.

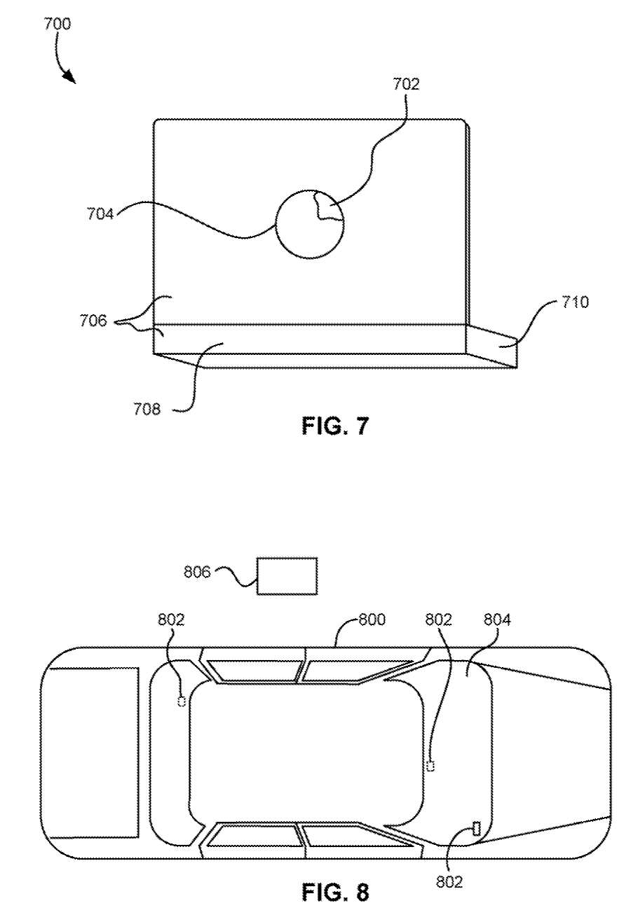

Again, it should be understood that the device can be any type of electronic device. One example mentioned above is a laptop PC. FIG. 7 illustrates a laptop PC 700 having a device tag 702 physically positioned behind an emblem 704 on a housing 706 of the laptop PC 700. This position is preferred, it is generally exposed to the environment, thereby providing the best signal. Note that the emblem 704 is preferably formed on an RF-transparent material such as plastic. The emblem may even be formed on the housing of the device tag 702. However, the device tag may be positioned elsewhere in the housing, such as towards the back 708 of the laptop PC 700, on the side 710 of the laptop PC 700, etc.

FIG. 8 illustrates a vehicle 800 according to one embodiment of the present invention. A device tag 802 is mounted to the vehicle at some location, preferably behind a window 804 of the vehicle such as the windshield or back window to allow relatively unimoended RF transmissions. The device tag 802 may be operatively coupled to the electrical system of the vehicle 800 via hardwired or wireless connection. as in previous embodiments, removal of the device tag 802 causes disablement of the vehicle, e.g., the engine will not start. Likewise, a valid user tag 806 may need to be present in order to start the vehicle. Illustrative RFID-based vehicular systems and methods suitable for integration into embodiments of the present invention are found in U.S. patent appplication entitled “RFID SYSTEMS AND METHODS” filed concurrently herewith to the same inventor and which is herein incorporated by reference.

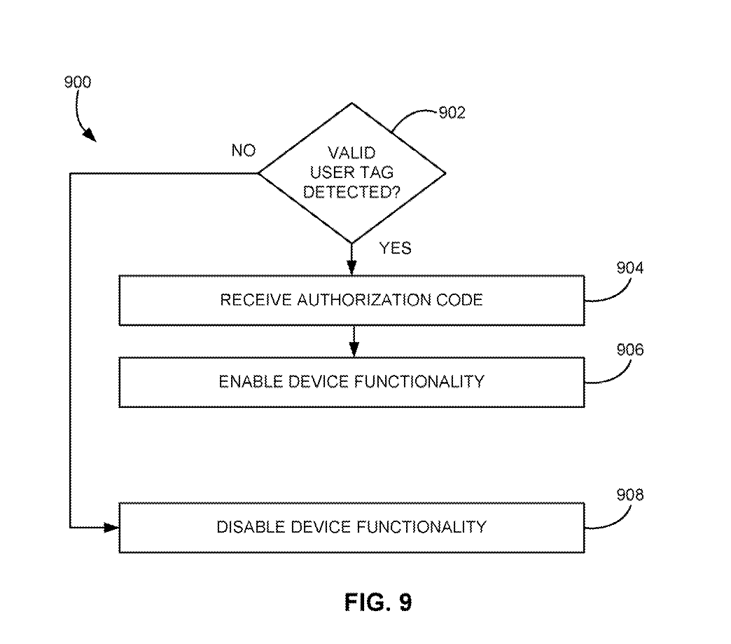

FIG. 9 depicts a method 900 for selectively enabling and disabling a device according to an embodiment of the present invention. Descision 902 determines whether a valid user tag has been detected. A valid user tag is one belonging to a user or user ID associated with the device, class of user authorized to use or process the device, etc. IN operation 904, if a valid user tag has been detected, a device tag receives an authorization code from an interrogator, the authorization code indicating that avalid user tag has been detected. Functionality of the device is enabled in operation 906 upon receiving the authorization code. If a valid user tag is not detected, functionality of the device is disabled in opertion 909 uopon receiving a transmission from an interrogtor indicating that avalid user tag is not detected. None that disabling device funtionality is meant to include not only a proactive step that causes disablement, but also a passive step that merely does not enable the device or some functions thereof.

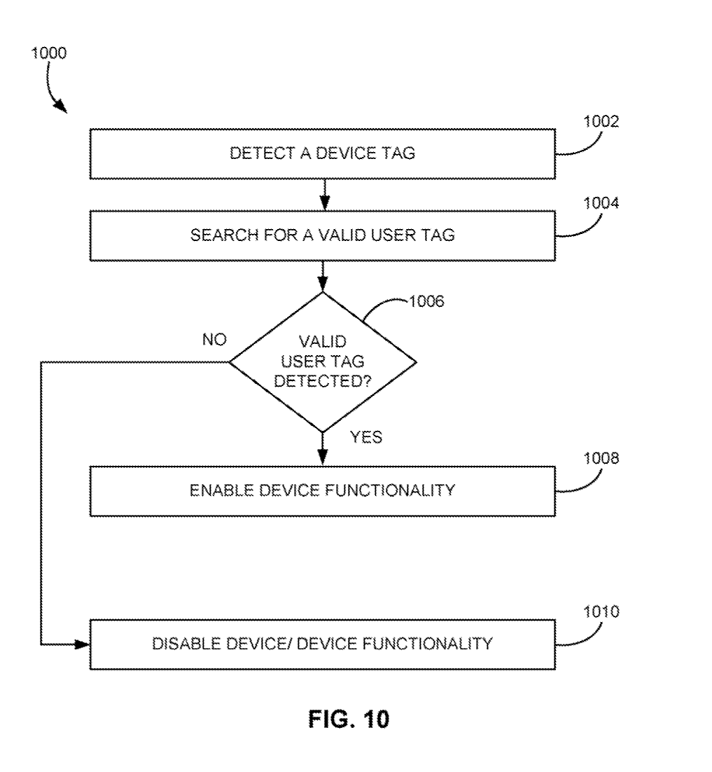

FIG. 10 depicts a method 1000 for selectively enabling or disabling a device according to an embodiment of the present invention. In operation 1002, a device tag coupled to adevice is detected. in operation 1004, a search is performed for a valid user tag. Decision 1006 determines whether a valid user tag has been detected. If a valid user tag has been detected, the device tag is instructed to enable the device in operation 1008 If a valid user tag is not detected, the device tag is instructed to diable the device in operation 1010. As mentioned above, detecting the device tag and searching for the valid uder tag may be performed in a passive mode. Also, the device may become disabled if the device tag is removerd from the device.

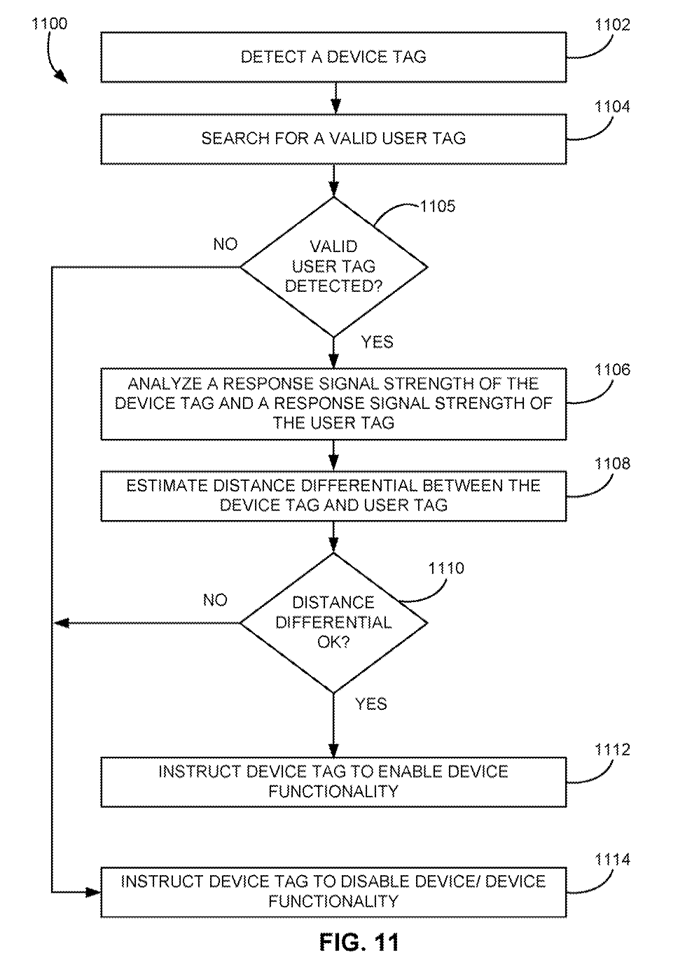

FIG. 11 depicts a method 1100 for selectively enabling or disabling a device according to an embodiment of the present invention. In operation 1102, a device tag coupled to a device is detected. In operation 1104, a search is performed for a valid user tag. Decision 1105 detemines whether a valid user tag has been detected. If a valid user tag is detected, in operation 1106, a response signal strength of the device tag and the user tag is analyed. In operation 1108, a distance differential between the device tag and the user tag is estimated. At decision 1110, a determination is made as to which of the following operations to perform based on the estimated distance differential: instructing the device tag to enable the device in operation 1112, or instructinng the device tag to disable the device in operation 1114. For ezxample, if the distance differential shows that the user tag and device tag are within a predetermined distance of one another, e.g., within 5 feet, then the distance differential is acceptable and operation 1112 is performed. If the distance differential indicates a greater distance between the tags, the distance differential is unacceptable and operation 1114 is performed. If a valid user tag is not detected at decision 1101, the device tag is intrsucted to disable the device in operation 1114.

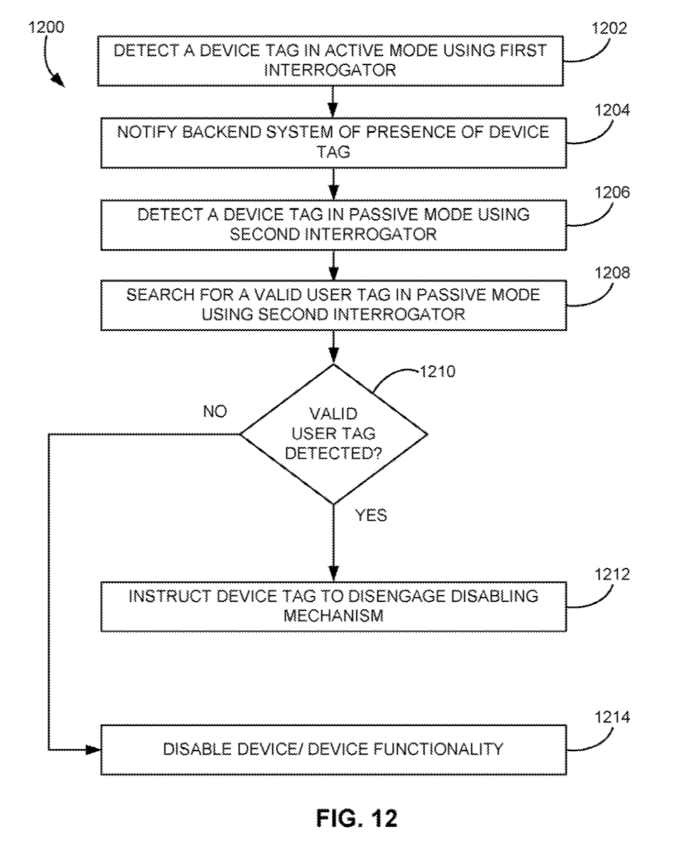

FIG. 12 illustrates a method 1200 for selcetively preventing disablement of a device having a device tag coupled thereto according to one embodiment of the present invention. In operation 1202, a first interrogator detects a device tag coupled to a device in an active mode, i.e., long range mode. In operation 1204, the first interrogator notifies the backend system that the device tag has been detected. The first interrogator may also send an instruction to the device tag to not cause disablement of the device (which may also include partial or total disablement) upon occurence of some event, e.g., elapse of a period of time, upon occurrence of an exception, e.g., until the first interrogator signal is no longer detected and no override code has been received, etc. In operation 1206, a second interrogator detects the device tag in a passive mode. As mentioned above, the passive mode has a more limited range than an active mode transmission, so may be more suitable for use exits, etc. In operation 1208, the second interrogator searches for a valid user tag in a pssive mode. Decision 1210 determines whether a valid user tag has been detected. If so, in operation 1212, an instruction is ent to the device tag to disengage a disabling mechanism that causes disablement of at least some functionality of the device. If a valid user is not detected, in operation 1214 (performed on the device by the device, device tag, etc.), the disabling mechanism causes dsiablment of at least some functionality of the device if the instruction is not received prior to occurence of an event. Again, illustrative events include elapsing of a predetermined period of time, failure of the device tag to detect a signal from the first interrogator, etc.

One skilled in the art will appreciate how the systems and methods presented herein can be applied to a plethora of scenarios and venues, including but not limited to all types of electronic devices. Accordingly, it should be understood that the systems and methods disclosed herein may be used with objects of any type and quantity.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A portable electric device, comprising:
an electrical system;
a controller coupled to the electrical system;
a display screen coupled to the electrical system;
input devices coupled to the electrical system;
an RFID tag coupled to the electrical system such that removal or disablment of the tag causes disablment at least some functionality of the device.

2. A device as recited in claim 1, wherein the tag is integrated into the electrical system, wherein removal of the tag physically severs a power supply to at least a portion of the electrical system.

3. A device as recited in claim 1, wherein the tag is integrated into the electrical system, whererin removal of the tag physically severs a communication line of the display screen.

4. A device as recited in claim 1, wherein the tag is integrated into the electrical system, wherein removal of the tag physically severs a communication line of at least one of the input devices.

5. A device as recited in claim 1, wherein the portable electronic device is a laptop personal computer, wherein the tag is physically positioned behind an emblem on a housing of the laptop personal computer.

6. A device as recited in claim 1, wherein removal of the tag permanently disables all functionality of the device.

7. A device as recited in claim 1, wherein the portable electronic device includes a telephone function.

8. A device as recited in claim 1, wherein the tag gathers biometric data.

9. A device as recited in claim 8, wherein the tag selectively enables functionality of the device based on the biometric data.

10. A device as recited in claim 9, wherein reference biometric data is programmed into the tag, the referebce biometric data being compared with the gathered biometric data for determining whether to selectively enable functionality of the device.

11. A Radio Frequency Identification (RFID) system comprising:
an RFID device tag control tag coupled to a device;
an RFID user tag associated with a user;
wherein the device tag is associated with the user tag,
wherein at least some functionality of the device is disabled based on whether or not a presence of the user tag is detected within a vicinity of the device tag.

12. A system as recited in claim 11, wherein detaching the device tag from the device causes disablement of at least some functionality of the device.

13. A system as recited in claim 13, wherein the device tag is integrated into an electrical system of the device.

14. A system as recited in claim 13, wherein detaching the device tag from the device severs a power supply to at least a portion of the electrical system.

15. A system as recited in claim 13, wherein detaching the device tag from the device severs a communication line of the display screen.

16. A system as recited in claim 13, wherein detaching the device tag from the device severs a communication line of at least one of the input devices.

17. A system as recited in claim 12, wherein detaching the device tag from the device permanently disables all functionality of the device.

18. A system as recited in claim 11, wherein the user tag is embodied in a badge.

19. A system as recited in claim 11, wherein removal of the device from a vicinity of the user tag causes disablement of at least some functionality of the device.

20. a system as recited in claim 19, further comprising an RFID interrogator in communication with the device tag and user tag, wherein the removal of the device from the vicinity of the user tag is detected by the RFID interrogator.

21. A system as recited in claim 19, wherein the removal of the device from the vicinity of the user tag is detected by an RFID interrogator operating in a passive mode.

22. A system as recited in claim 19, further comprising a first RFID interrogator in communication with the device tag and the user tag in an active mode, and a second RFID interrogator operating in a passive mode, wherein the device tag and the user tag are at least periodically monitored by the first RFID interrogator, wherein the removal of the device from the vicinity of the user tag is detected by analyzing presence or lack of communication between the tags and the first and second RFID interrogators.

23. A system as recited in claim 22, wherein at least some functionality of the device is disabled if the device tag is detected by the second RFID interrogator and the user tag is not also detected by the second RFID interrogator.

24. A system as recited in claim 11, wherein the device is laptop personal computer.

25. A system as recited in claim 11, wherein the device includes a telephone function.

26. A system as recited in claim 11, wherein the device is a vehicle.

27. A system as recited in claim 11, wherein the device tag gathers biometric data.

28. A system as recited in claim 27, wherein the device tag selectively enables functionality of the device based on the biometric data.

29. A system as recited in claim 28, wherein reference biometric data is programmed into the edevice tag by the user associated with the user tag, the reference biometric data being compared with the gathere biometric data for determining whether to selcetively enable functionality of the device.

30. A Radio Frequency Identification (FRID) system, comprising;
an RFID device tag coupled to a portable electronic device;
an RFID user tag associated with a user;
wherein the device tag is associated with the user tag,
wherein at least some functionality of the device is disabled based on whether or not a presence of the user tag is detected within a vicinity of the device tag,
wherein availability of at least some functionality of the device is dependent upon a presence of the user tag being detected within a vicinity of the device tag,
wherein detaching the device tag from the device causes disablement of at least some functionality of the device.

31. A system as recited in claim 30, wherein the device tag is integrated into an electrical system of the device.

32. A system as recited in claim 31, wherein detaching the device tag from the device severs a power supply to at least a portion of the electrical sysytem.

33. A system as recited in claim 31, wherein deatching the device tag from the device severs a communication line of the display screen.

34. A system as recited in claim31, wherein detaching the device tag from the device severs a communication line of at least one f the input devices.

35. A system as recited in claim 30, wherein detaching the device tag from the device permanently disables all functionality of the device.

36. A system as recited in claim 30, wherein removal of the device from a vicinity of the user tag causes disablement of at least some functionality of the device.

37. A system as recited in claim 30, wherein removal of the device from a vicinity of the user tag causes disablement of at least some functionality of the device.

38. A system as recited in claim 37, further comprising an RFID interrogator in communication with the device tag and user tag, wherein the removal of the device from the vicinity of the user tag is detected by the RFID interrogator.

39. A system as recited in claim 37, wherein the removal of the device from the vicinity of the user tag is detected by an RFID interrogator operating in a passive mode.

40. A system as recited in claim 37, further comprising a first RFID interrogator in communication with the device tag and user tag in an active mode, and a second RFID interrogator operating in a passive mode, wherein the device tag and the user tag are at least periodically monitored by the first RFID interrogator, wherein the removal of the device from the vicinity of the user tag is detected by analyzing presence or lack of communication between the tags and the first and second RFID interrogators.

41. A system as recited in claim 40, wherein at least some functionality of the device is disabled if the device tag is detected by the second RFID interrogator and the user tag is not also detected by the second RFID interrogator.

42. A system as recited in claim 30, wherein the device is a laptop personal computer.

43. A system as recited in claim 30, wherein the device includes a telephone function.

44. A system as recited in claim 30, wherein the device is a vehicle.

45. A system as recited in claim 30, wherein the device tag gathers biometric data.

46. A system as recited in claim 45, wherein the device tag selectively enables functionality of the device based on the biometric data.

47. A system as recited in claim 46, wherein reference biometric data is programmed into the device tag by the user associated with the user tag, the reference biometric data being compared with the gathered biometric data for cetermining whether to slectively enable functionality of the device.

48. A laptop personal computer, comprising;
an electrical system;
a processor coupled to the electrical system;
a display screen coupled to the electrical system;
input devices coupled to the electrical system;
an RFID tag integrated into the electrical system such that removal of the tag disables at least some functionality of the laptop personal computer.

49. A laptop personal computer as recited in claim 48, wherein removal of the tag physically severs a power supply to at least a portion of the electrical system.

50. A laptop personal computer as recited in claim 48, wherein removal of the tag physically severs a communication line of the display screen

51. A laptop personal computer as recited in claim48, wherein removal of the tag physically severs a communication line of at least one of the input devices.

52. A laptop personal computer as recited in claim 48, wherein removal of the tag permanently disables all functionality of the laptop personal computer.

53. A laptop personal computer as recited in claim 52, wherein the tag is physically positioned behind an emblem on a housing of the laptop personal computer.

54. A laptop personal computer as recited in claim 48, wherein the tag gathers biometric data.

55. A laptop personal computer as recited in claim 54, wherein the tag selectively enables functionality of the laptop personal computer based on the biometric data.

56. A laptop personal computer as recited in claim 55, wherein reference biometric data is programmed into the tag, the reference biometric data being compared. with tha gathered biometric data for determining whether to selectively enable functionality of the device.

57. A method for selectively enabling and disabling a device, the method comprising:
receiving an authorization code from an interrogator, the authorization code indidcating that a valid user tag has been dectected;
enabling functionality of the device upon receiving the authorization code; and
disabling functionality of the device upon receiving a transmission from an interrogator indicating that a valid user tag is not detected.

58. A method for selectively enabling or disabling a device having a device tag coupled thereto, the method comprising;
detecting a device tag coupled to a device;
searching for a valid user tag;
performing at least one of the following operations:
instructing the device tag to disable the device if a valid user tag is not detected
instructing the device tag to enable the device if a valid user tag is detected.

59. A method as recited in claim 58, wherein the detecting the device tag and searching for a valid user tag are performed in a passive mode.

60. A method as recited in claim 58, wherein at least some functionality of the device is disabled if the device tag is removed from the device.

61. A method for selectively enabling or disabling a device having a device tag coupled thereto, the method comprising:
detecting a device tag coupled to a device;
detecting a valid user tag;
analyzing a response signal strength of the device tag and the user tag;
estimating a difference between the device tag and the user tag; and
determining which of the following operations to perform based on the estimated distance differential:
instructing the device tag to disable the device; and
instructing the device tag to enable the device.

62. A method as recited in claim 61, further comprising instructing the device tag to disable the device if a valid user tag is not detected.

63. A method for selectively preventing disablement of a device having a device tag coupled thereto, the method comprising:
detecting a device tag coupled to a device in an active mode using a first interrogator;
detecting the device tag in a passive mode using a second interrogator;
searching for a valid user tag in a passive mode using the second interrogator;
sending an instruction to the device tag to disengage a disabling mechanism that causes disablement of at least some functionality of the device if a valid user tag is detected by the second interrogator,
wherein the disabling mechanism causes disablement of at least some functionality of the device if the instruction is not received prior to occurrence of an event.

64. A method as recited in claim 63, wherein at least some functionality of the device is disbaled if the device tag is removed from the device.

65. A method as recited in claim 63, wherein the event is elapsing of a predetermined period of time.

66. a method as recited in claim 63, wherein the event is failure of the device tag to detect a signal from the first interrogator.
